(19) United States
(12) Patent Application Publication
(10) Pub. No.: US 2016/0021869 A1
(43) Pub. Date: Jan. 28, 2016

(54) Rotating Bucket Blind Apparatus

(71) Applicant: Darion George, Flintville, TN (US)

(72) Inventor: Darion George, Flintville, TN (US)

(21) Appl. No.: 14/806,282

(22) Filed: Jul. 22, 2015

Related U.S. Application Data
(60) Provisional application No. 62/028,665, filed on Jul. 24, 2014.

(51) Int. Cl. A01M 31/02; A47C 3/18; A47C 1/00; A01M 31/06

(52) U.S. Cl. CPC A01M 31/025; A01M 31/06; A01M 31/02; A47C 3/18; A47C 1/00

(57) ABSTRACT

The present disclosure is a hunting apparatus that has a rotating chair that is rotatably coupled to a chair base and a frame that is coupled to the rotating chair. Additionally, the hunting apparatus has a blind coupled to the frame that rotates when the rotating chair rotates relative to the chair base.

### CROSS-REFERENCE TO RELATED APPLICATION

This application claims priority to U.S. provisional patent application Ser. No. 62/028,665 entitled Rotating Bucket Blind Apparatus, filed on Jul. 24, 2014, which is incorporated herein in its entirety.

### BACKGROUND

Hunters often use different methods, apparatuses, and devices when hunting. As an example, some hunters use deer stands when hunting deer. The deer stand can be free standing or coupled to a tree (also called a tree stand). A tree stand allows a hunter to situate himself above the line of sight so as to give the hunter a better view when taking a shot at game roaming below the tree stand.

Additionally, hunters use ground blinds that rest on the ground. The blinds typically conceal the hunter so that he/she cannot be seen by roaming game. Some ground blinds have openings through which the hunter can take a shot at the game while remaining hidden within the blind. Blinds can take various shapes and be made of many different types of materials. For example, the blinds may be made of camouflage material and have various openings or windows through which the hunter can fire his/her weapon.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a perspective view of a rotating bucket blind in accordance with an embodiment of the present disclosure.

FIG. 2 is a perspective view of the rotating bucket blind depicted in FIG. 1 with the blind removed.

FIG. 3 is a perspective view of a frame of the rotating bucket blind of FIG. 1 depicting a gun rest in an upward position.

FIG. 4 is a perspective view of the frame of the rotating bucket blind of FIG. 1 with the seat cover removed depicting the gun rest in a lowered position.

FIG. 5 is a front view depicting the frame and hinge mechanism for raising and lowering the gun rest of the rotating gun blind of FIG. 1.

FIG. 6 is a perspective view of the frame of the rotating bucket blind of FIG. 1 with the seat cover removed.

FIG. 7 is a side view of a seat of the rotating bucket blind of FIG. 1 depicting a seat fixedly coupled to a base plate, which is rotatably coupled to a coupling plate.

FIG. 8 is a perspective view of a strap and bracket of the rotating bucket blind of FIG. 1.

FIG. 9 is a perspective view of a strap and bracket coupled to a buckle of the rotating bucket blind of FIG. 1.

FIG. 10 is a cross-sectional view of an inverted chair base of the rotating bucket blind of FIG. 1 depicting the mechanism by which the seat is coupled to a chair base.

FIG. 11 is a cross-sectional view of the chair base of the rotating bucket blind of FIG. 1 depicting the mechanism by which the chair base is secured to the ground.

### DETAILED DESCRIPTION

Embodiments of the present disclosure generally pertain to rotating bucket blind apparatuses. In particular, a rotating bucket blind in accordance with an embodiment of the present disclosure comprises a dome-shaped frame on which a blind is secured. The dome-shaped frame is coupled to a bucket on which a seat is affixed. The seat is rotatable with the blind. Additionally, the rotating bucket blind comprises at least two connectors that are further connected to the rotating seat. In one embodiment, a decoy is connected to one of the connectors, and a gun rest is connected to the other connector. Notably, as the seat rotates, the blind (and frame), the decoy, and the gun rest rotate therewith.

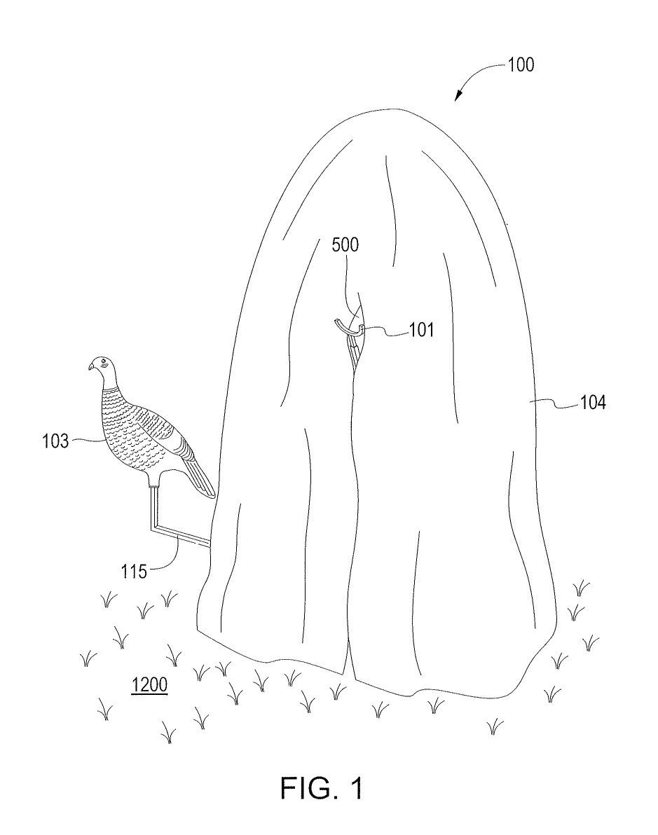

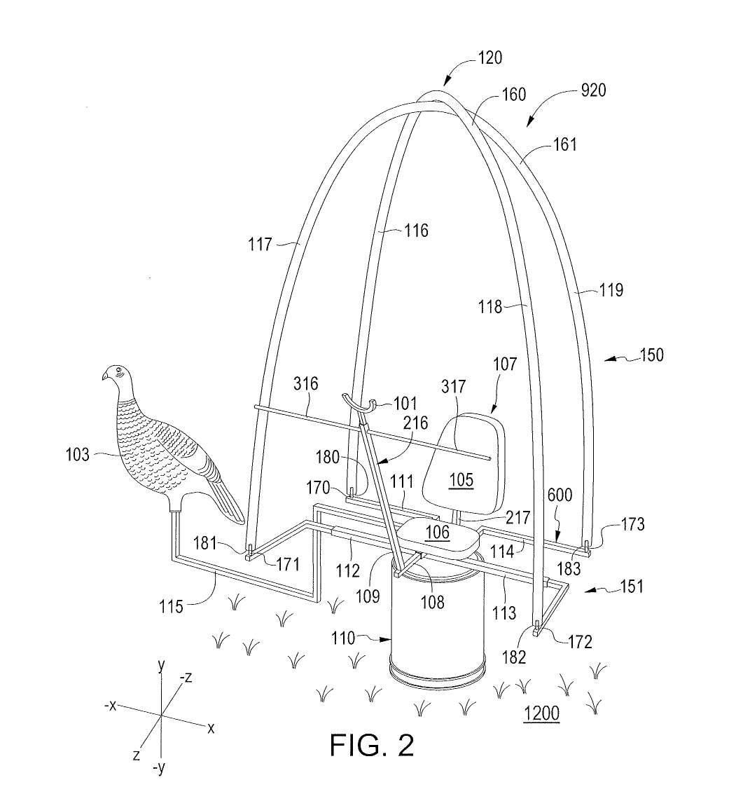

FIG. 1 depicts an exemplary rotating bucket blind 100 in accordance with an embodiment of the present disclosure. The rotating bucket blind 100 comprises a blind 104 that is coupled to a frame (shown in FIG. 2). The rotating bucket blind 100 is used during hunting and shields a hunter (not shown) while he/she waits on game to appear. In this regard, a hunter sits within the blind, which is described further herein, and when game appears, he/she may shoot the game from inside the rotating bucket blind 100.

Note that the blind 104 may be comprised of any type of flexible, draping material known in the art or future-developed. In one embodiment, the blind 104 is made of a transparent material so that the hunter may view game from within the rotating bucket blind 100. As examples, the material used for the blind 104 may be synthetic fibers, polyester, acrylic, and/or cotton blends. In this regard, the material may be treated via a chemical process such that the material repels water and holds up well to the sun. Note that other types of materials not listed that are flexible and transparent and that camouflage the hunter during use of the bucket blind 100 are possible in other embodiments.

The rotating bucket blind further comprises a gun rest 101. The gun rest 101 is coupled to the frame (shown in FIG. 2) of the rotating bucket blind 100 and protrudes from an opening 500 in the blind 104. Note that the opening 500 may be a slit-type opening that allows for ingress and egress. The opening 500 may begin at the point where the gun rest 101 protrudes from the opening 500, or slightly above, and may extend to the ground 1200. Further, the opening may comprise fasteners (not shown) that may be used to keep the opening closed during use. As an example, the rotating bucket blind 100 may comprise Velcro that attaches the opening 500 during use to visually shield and protect the hunter.

Further, protruding from the rotating bucket blind 100 is a decoy 103. The decoy 103 is coupled via an arm 112 to the frame (shown in FIG. 2) of the rotating bucket blind 100. As will be described further herein with reference to FIG. 2, the rotating bucket blind 100 is adapted and arranged to rotate. Thus, the hunter situated within the rotating bucket blind 100, which will be described further herein, may rotate the blind 104, and as the blind 104 rotates, the decoy 103 and the gun rest 101 rotate accordingly.

FIG. 2 depicts the rotating bucket blind 100 with the blind 104 removed. Removal of the blind 104 reveals the inner workings of the bucket blind 100. During use in hunting, the blind 104 is coupled to a frame 920 (as referenced with respect to FIG. 1) and shields the hunter while waiting for game. As indicated hereinabove, the blind 104 is made of a transparent material so that the hunter may see game within his sight roaming outside of the bucket blind 100.

In the embodiment depicted, the frame 920 is dome-shaped. However, the frame may be other shapes in other embodiments. For example, the frame may be in the shape of a rectangle or a triangle in other embodiments. The dome-shaped frame 920 is merely exemplary. The frame 920 comprises a vertical member 150 and a horizontal member 151, and each is now described.

The vertical member 150 of the frame 920 comprises four legs 116-119. In the embodiment shown, the legs 116 and 118 are formed of an integral, unitary piece 160. Likewise, the legs 117 and 119 are formed of an integral, unitary piece 161. In the embodiment depicted, the integral, unitary pieces are bent so as to cross at an apex 120 of the vertical member 150 thereby forming the legs 116-119.

In one embodiment, the legs 116 and 118 may be formed of a single, unitary piece of polyvinyl chloride (PVC) piping that is bent at the apex 120 so that the legs 116 and 118 extend downwardly toward the ground. Further, the legs 117 and 119 may also be formed of a single, unitary piece of PVC piping that is bent at the apex 120 so that the legs 117 and 119 extend downwardly toward the ground. In such an embodiment, the two separate pieces of PVC piping, i.e., the unitary piece 160 of PVC piping forming legs 116 and 118 and the unitary piece 161 of PVC piping forming legs 117 and 119, are adapted and arranged to cross at the apex 120 thereby forming the four legs 116-119. In one embodiment, the unitary piece forming the legs 116 and 118 may be coupled to the unitary piece forming the legs 117 and 119 via a collar (not shown) comprising a Velcro fastener that wraps around each unitary piece to secure them together.

Note that in another embodiment, the legs 116-119 may be separate members. In such an embodiment, each of the legs 116-119 may be coupled together at the apex 120. For example, the legs 116-119 may be coupled together at the apex 120 via a cross tube connector (not shown).

The horizontal member 151 comprises a rotating chair 107 and a frame 600 and the chair 107 is coupled to a chair base 110. The chair 107 is rotatably coupled to the chair base 110. Further, the rotating chair 107 is fixedly coupled to the frame 600 which is described further herein.

In the embodiment shown in FIG. 2, the chair 107 comprises a seat 106 and a chair back 105. However, the chair back 105 is an optional component of the rotating bucket blind 100 and may not be present in other embodiments of the rotating bucket blind 100. In this regard, the chair 107 may comprise, for example, only the seat 106. The seat 106 is coupled to the chair back 105 via a coupling rod 217.

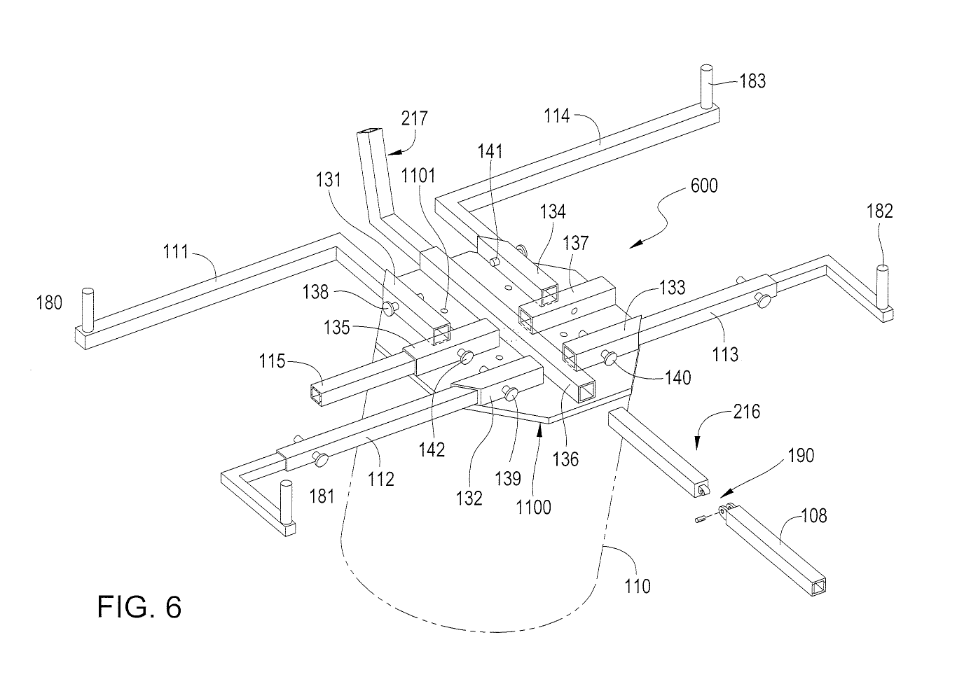

As noted hereinabove, the chair 107 is further coupled to the frame 600. In this regard, the frame 600 comprises four L-shaped bars 111-114. Leg 116 is coupled to the L-shaped bar 111, leg 117 is coupled to the L-shaped bar 112, leg 118 is coupled to the L-shaped bar 113, and leg 119 is coupled to the L-shaped bar 114. Because the frame 600 is coupled to the chair 107, when the seat rotates, the frame 600 (including the rods 111-114) rotates as well. Note that the bars 111-114 may be coupled to the rotating chair 107 via welding or other method for coupling the bars 111-114 to the rotating chair 107 known in the art or future-developed. One such method is further described with reference to FIG. 6.

The L-shaped bars 112 and 113 extend outwardly and forwardly from the rotating chair 107. The L-shaped bar 112 extends outwardly in the −x direction, forms an “L,” and extends forwardly in the +z direction. Further, the L-shaped bar 113 extends outwardly in the +x direction, forms an “L,” and extends forwardly in the +z direction. Because the L-shaped bars 112 and 113 extend in the +z direction away from the chair 107, there is room between the rotating chair 107 and the opening 500 (FIG. 1) in the blind so that there is space for a hunter to place his/her feet during use.

Further, the L-shaped bars 111 and 114 extend backwardly and outwardly from the rotating chair 107. In this regard, the L-shaped bar 111 extends backwardly in the −z direction and outwardly in the −x direction. Also, the L-shaped bar 114 extends backwardly in the −z direction and outwardly in the +x direction. Note that the backwardly extending L-shaped bars 111 and 114 have lengths that are less than the forwardly extending L-shaped bars 112 and 113. In this regard, the L-shaped bars 111 and 114 are coupled to the back of the rotating chair 107 and thus no room is needed behind the hunter during use.

In one embodiment, the ends of the legs 116-119 are hollow and include openings 170-173. In such an embodiment, the L-shaped bars 111-114 have protrusions 180-183 that extend upwardly in the +y direction. Thus, the openings 170-173 receive the protrusions extending from the bars 111-114 that couple to the legs 116-119 via the openings 170-173 to the frame 600.

In one embodiment, the frame 600 comprises metal bars 111-114. However, other types of structures comprised of other types of materials may be used in other embodiments. For example, the bars 111-114 may be rods having a circular cross-section. Further the bars 111-114 may be solid or hollow. Additionally, the bars 111-114 may be made of a durable plastic or the like in other embodiments.

As indicated hereinabove, the rotating bucket blind 100 comprises an arm 115, and coupled at the end of the arm 115 is the decoy 103. In the embodiment shown, the arm 115 is a metal rod that may be solid or hollow. The arm 115 is U-shaped with an extension that couples to the chair 107.

Furthermore, as indicated hereinabove, the rotating bucket blind 100 comprises the gun rest 101, which attaches to the chair 107 via an extended L-shaped (i.e., the L having an obtuse angle) bar 216 having two members 108 and 109. Member 109 attaches to the gun rest 101, and member 108 attaches to the front of the chair 107. Note that the position and location of the L-shaped member 108 may attach to other locations on the chair. When attached to the chair 107, the gun rest 101 rotates with rotation of the chair 107.

In one embodiment, the frame 600 does not couple to the legs 116-119. Instead, the frame 600 couples to a fold up or pop-up tent apparatus (not shown). In such an embodiment, the tent may comprise sleeves (not shown) that couple to an abbreviated frame 600. The abbreviated frame may merely include rods 111-114, and the tent may couple to the rods 111-114. In such an embodiment, there would be no need for the vertical member 150, since a tent and its frame would couple to the frame 600.

In one embodiment, the rod 216 is coupled to two arms 316 and 317. The arms extend outwardly in the −x and +x directions, respectively. The arms 316 and 317 above the blind 104 causing the blind 104 to be secured away from the hunter so as not to interfere when the hunter is preparing to shoot or is taking a shot.

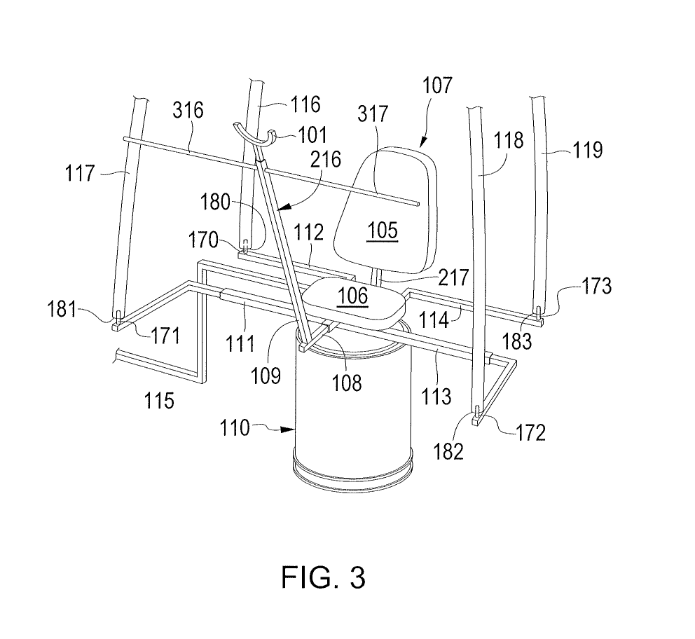

FIG. 3 depicts a perspective view of chair 107 and the coupling of the vertical member 150 to the frame 600. Further, FIG. 3 shows the frame 600 coupled to the chair 107, which is described in more detail with reference to FIG. 6.

As described hereinabove, the bars 111-114 couple to the chair 107, for example via welding. However, other coupling methods may be used in other embodiments.

In FIG. 3, the bar 216 that is coupled to the gun rest 101 is shown in an upward position. During use, when the blind 104 (FIG. 1) is in place and coupled to the vertical member 150 (FIG. 2), the gun rest 101 extends out past the blind 104, which allows a hunter who is sitting in the chair 107 to aim and shoot game while remaining within the rotating bucket blind 100.

Additionally, FIG. 3 shows protrusions 180-183 of the L-shaped bars 111-114, respectively. These protrusions extend upwardly in the +y direction. These protrusions of the L-shaped bars 111-114 couple to openings 170-173.

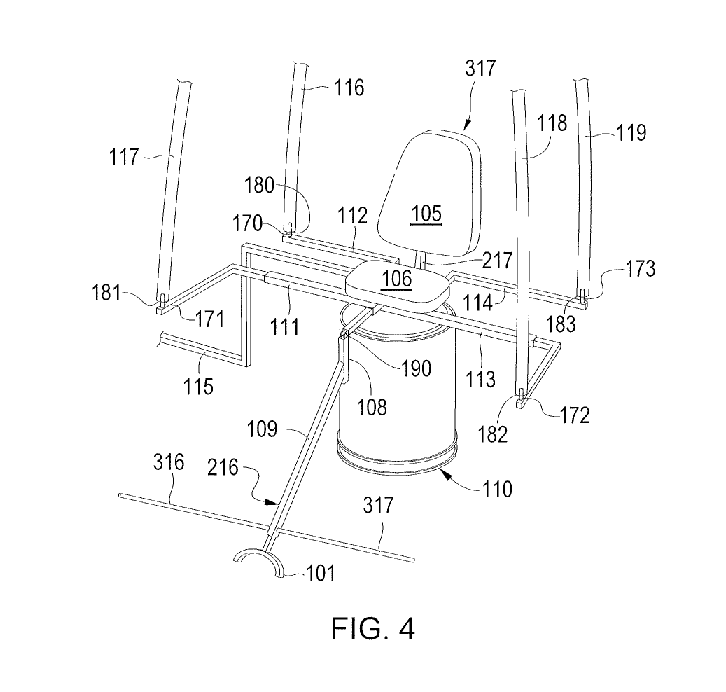

FIG. 4 is a perspective view of the bucket blind 100 with the blind 104 (FIG. 1) removed and the gun rest 101 in a lowered position, i.e., resting on the ground. Thus, if the hunter desires to leave the confines of the blind 104 (FIG. 1), he/she can lower the gun rest 101, which allows for easier egress and ingress into and out of the confines of the blind 104 through the opening 500 (FIG. 1).

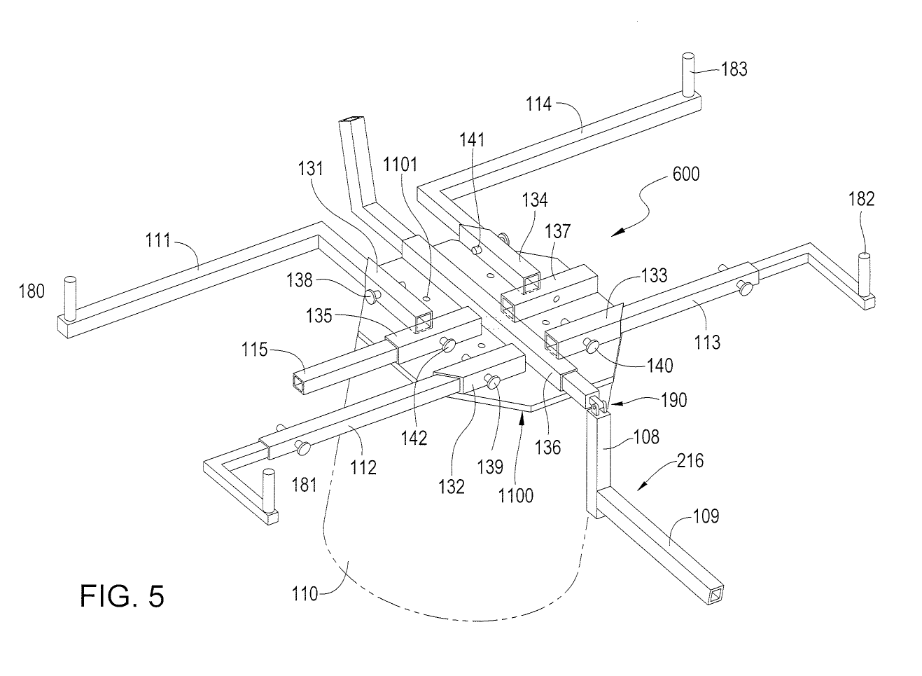

FIG. 5 is a detailed perspective view of the chair 107 where the rod 216 couples to a sleeve 136. In this regard, the sleeve 136 houses a hinge structure 190 enabling the rod 216 to be raised and lowered as needed. In one embodiment, the hinge structure 190 allows for the rod 216 to be raised and the member 109 fits within the sleeve 136 to retain the rod 216 in an upward position for use during hunting.

FIG. 6 is a perspective view with the seat 106 removed. Note that during normal operation, the seat 106 is fixedly coupled to a base plate 1100 via fasteners (not shown) that are received via openings 1101. However, for purposes of explaining the disclosure, the seat 106 is shown as having been removed in FIG. 6.

Coupled to the base plate 1100 is a plurality of sleeves 131-137. Each sleeve receives a one of the metal rods identified herein, which is now described further. Sleeves 131-134 receive metal rods 111-114, respectively, which are retained by fasteners 138-141. These metal rods 111-114 make up the frame 600, as described with reference to FIG. 2.

Sleeve 136 receives on a first end the metal rod 216 that is coupled to the gun rest 101

(FIG. 1) and on a second end a rod 217 that retains the back 105 (FIG. 2) of the chair 107 (FIG. 2). Further, sleeve 135 receives the metal rod 115 that is coupled to the decoy 103 (FIG. 1), and is retained by fastener 142. Note that there is an additional sleeve 137 that may be a multipurpose sleeve for attaching to the chair 107 additional implements for use during a hunting expedition.

In one embodiment, the sleeves 131-136 are separate and distinct components from the base plate 1100. In such an embodiment, the sleeves 131-136 may be welded to the base plate 1100.

However, in other embodiments the base plate 1100 and the sleeves 131-136 form a unitary piece, and the sleeves 131-136 are integral with the base plate 1100. In this embodiment, the base plate 1100 and the sleeves 131-136 may be comprised of a polyvinyl or plastic material. Thus, the unitary piece could be formed from a mold, for example.

In even another embodiment, the sleeves 131-136 may be replaced with openings in the base plate 1100 in which rods or poles could be inserted. In this embodiment, the frame 600 would comprise rods that coupled to the openings in the base plate 1100.

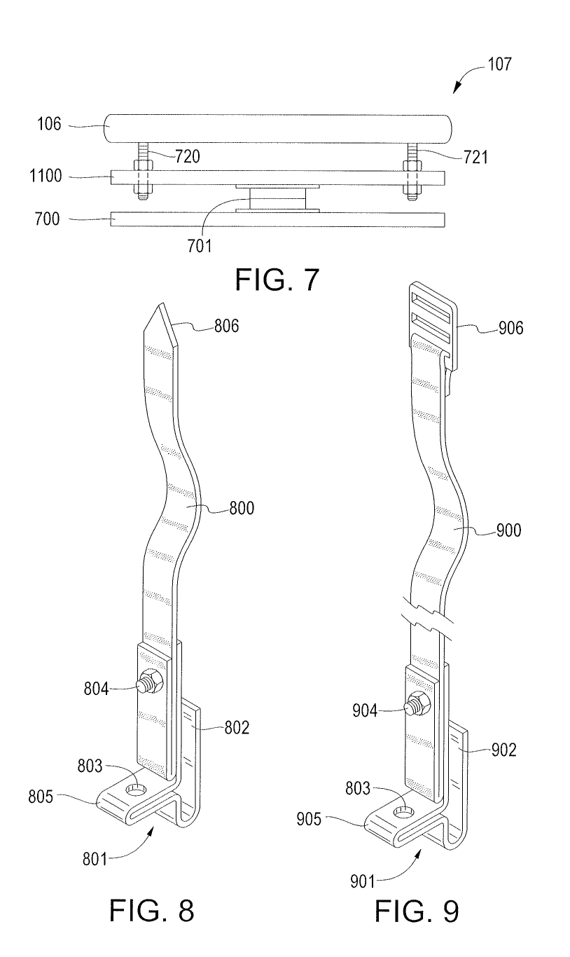

FIG. 7 is a side view of the chair 107. As shown in the side view and as described hereinabove, the seat 106 is fixedly coupled to the base plate 1100 via fasteners 720 and 721. Further, as described hereinabove with reference to FIG. 6, the plurality of rods 111-115, 216, and 217 are fixedly coupled to the base plate 1100. Additionally, the chair 107 comprises a coupling plate 700, and the base plate 1100 is rotatably coupled to the coupling plate 700 via a threaded connector 701. In operation, the seat 106 and the base plate 1100 rotate relative to the coupling plate 700, which is fixedly coupled to the chair base 110 (FIG. 6), which is described further herein.

In one embodiment, a strap apparatus fixedly couples the coupling plate 700 to the chair base 110. The strap apparatus is now described with reference to FIGS. 8-11.

FIG. 8 depicts a strap 800 that has a free end 806 and an opposing end coupled to a bracket 801 via a fastener 804. The bracket 801 comprises a hook 802 that is U-shaped. Further, the bracket 801 comprises another U-shaped member 805 that is formed at an approximate right angle relative to the hook 802. Note that the U-shaped member 805 comprises an opening 803 for receiving a pin (not shown), which is described further herein.

FIG. 9 depicts a strap 900 that is coupled at one end to a buckle 906. On the opposing end, the strap 900 is coupled to a bracket 901 via a fastener 904. Similar to bracket 801, the bracket 901 comprises a hook 902 that is U-shaped. Further, the bracket 901 comprises another U-shaped member 905 that is formed at an approximate right angle relative to the hook 802. Note that the U-shaped member 905 comprises an opening 903 for receiving a pin (not shown), which is described further herein.

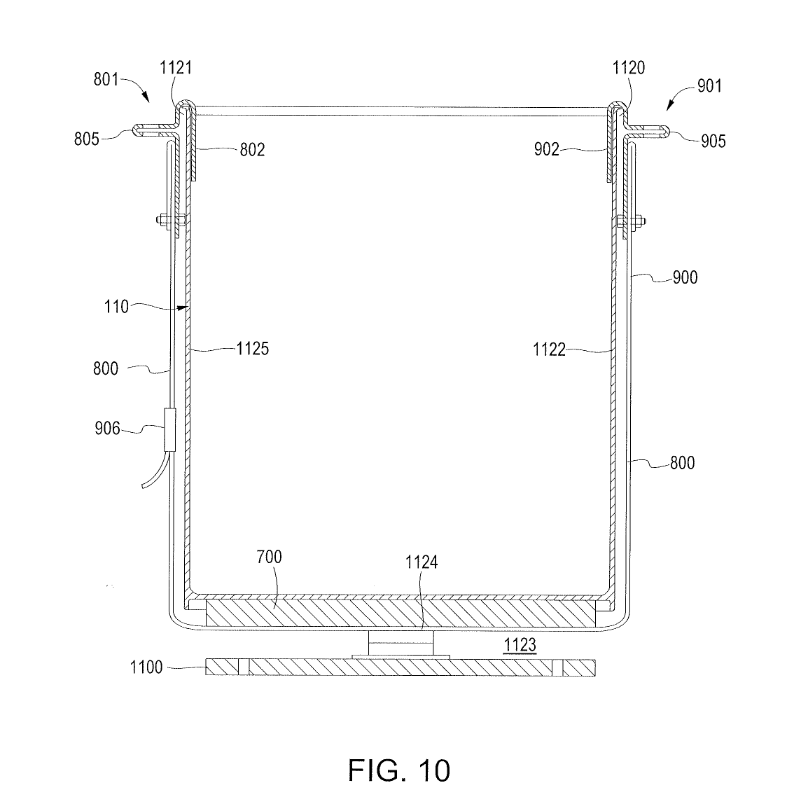

FIG. 10 is a cross-sectional view showing coupling of the chair base 110 to the coupling plate 700. For illustration, the chair base 110 is shown inverted. On one side, the bracket 901 is coupled to a lip 1120 of the chair base 110. In this regard, the hook 902 is installed on the lip 1120. The strap 900 attached thereto is wrapped around a side 1122 of the chair base 110 and through space 1123 between the base plate 1100 and the coupling plate 700 on a top side 1124. The strap 900 is stretched so that the buckle 906 is adjacent a side 1125 of the chair base 110.

The buckle 906 is slidably coupled to an end of the strap 800. Further, the opposing end of the strap 800 is coupled to the bracket 801, as described hereinabove. The bracket 801 is coupled to a lip 1121 of the chair base 110. In this regard, the hook 802 is installed on the lip 1121. Thus, as the buckle 906 is tightened, the straps 900 and 800 tighten to secure the coupling plate 700 to the chair base 110.

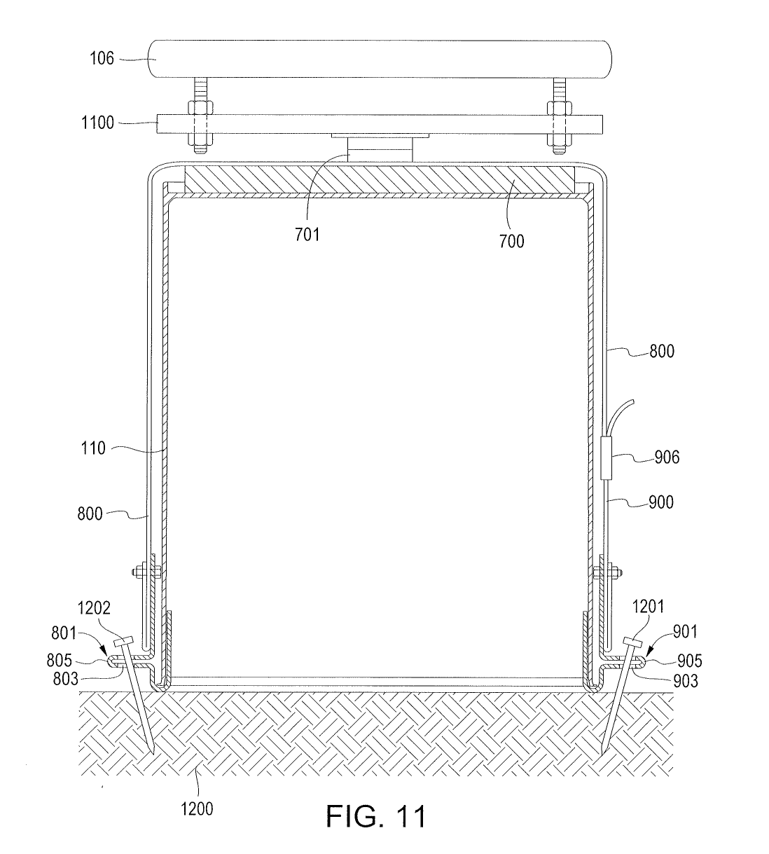

FIG. 11 depicts the chair base 110 having the coupling plate 700 fixedly coupled thereto and rotatably coupled to the base plate 1100, which is fixedly coupled to the seat 107. As shown, the straps 800 and 900 couple together via the buckle 906. Their respective brackets 801 and 901 couple to the lips 1121 and 1120, respectively. Thus, the coupling plate 700 is securely fixed to the chair base 110.

Additionally, the U-shaped members 805 and 905 project outwardly from the brackets 801 and 901 adjacent the ground 1200. Each U-shaped member 805 and 905 comprises openings 803 and 903, respectively. Pins 1202 and 1201 are inserted through the openings 803 and 903, respectively. Thus, the chair base 110 is secured to the ground 1200.

The afore-described details show relevant components and aspects of a rotating bucket blind in accordance with an embodiment of the present disclosure. Note that other components and aspects of the present disclosure are possible in other embodiments.

What I claim is:

1. A hunting apparatus, comprising:
a rotating chair that is rotatably coupled to a chair base;
a frame that is coupled to the rotating chair; and
a blind coupled to the frame that rotates when the rotating chair rotates relative to the chair base.

2. The hunting apparatus of claim 1, wherein the rotating chair comprises a seat, a base plate, and a coupling plate, and the seat is fixedly coupled to the base plate.

3. The hunting apparatus of claim 2, wherein the seat and the base plate are rotatably coupled to the coupling plate that is fixedly coupled to the chair base.

4. The hunting apparatus of claim 3, wherein a strap apparatus couples the coupling plate to the chair base.

5. The hunting apparatus of claim 4, wherein the strap apparatus comprises a first strap that is coupled on a first end to a first bracket and on a second end to a buckle.

6. The hunting apparatus of claim 5, wherein the strap apparatus further comprises a second strap that is coupled on a first end to a second bracket.

7. The hunting apparatus of claim 6, wherein the bracket of the first strap and the bracket of the second strap couple each comprises a first hook and a second hook, respectively, and the first hook couples to a lip of the chair base and the second hook couples to the lip of the chair base.

8. The hunting apparatus of claim 7, wherein a second end of the second strap couples to the buckle that is coupled to the second end of the first strap and the strap is installed around a first side of the chair base, between the base plate and the coupling plate, and around a second side of the chair base such that when the buckle is tightened, the coupling plate is removeably coupled to the chair base.

9. The hunting apparatus of claim 8, wherein the first bracket and the second bracket comprise a first u-shaped member and a second u-shaped member that are at a right angle relative to the first hook and the second hook, respectively.

10. The hunting apparatus of claim 9, wherein the chair base is secured to a ground by placing pins through a first opening and a second opening in the first u-shaped member and the second u-shaped member, respectively, and through the ground.

11. The hunting apparatus of claim 1, wherein the frame comprises a vertical member and a horizontal member.

12. The hunting apparatus of claim 10, wherein the vertical member comprises at least four legs that cross at an apex and form a dome shape.

13. The hunting apparatus of claim 12, wherein the four legs are coupled together at the apex.

14. The hunting apparatus of claim 12, wherein the horizontal member comprises at least four bars that are coupled to a base plate that is coupled to a seat of the rotating chair.

15. The hunting apparatus of claim 14, wherein each of the four bars comprises a protrusion.

16. The hunting apparatus of claim 15, wherein each of the four legs comprises openings that coupled to the protrusions thereby creating a dome-shaped frame.

17. The hunting apparatus of claim 16, wherein the blind is coupled to the vertical member and the horizontal member thereby creating a space inside the blind for a hunter to sit in the rotating chair and wait for an appearance of game.

18. The hunting apparatus of claim 1, further comprising a decoy that is fixedly coupled to a base plate that is coupled to the rotating chair such that when the chair rotates, the decoy rotates.

19. The hunting apparatus of claim 1, further comprising a gun rest that is fixedly coupled to a base plate that is coupled to the rotating chair such that when the chair rotates, the gun rest rotates.

20. The hunting apparatus of claim 19, wherein the gun rest is hingedly coupled to the base plate such that the gun rest may be raised or lowered during hunting.
